(19) United States
(12) Patent Application Publication
(10) Pub. No.: US 2019/0249851 A1
(43) Pub. Date: Aug. 15, 2019

(54) LIGHT TUBE

(71) Applicant: Ericson Manufacturing Company, Willoughby, OH (US)

(72) Inventors: John E. Ericson, JR., Chagrin Falls, OH (US); Ronald W. Hughes, Thompson, OH (US); Jeffrey R. Angle, Newbury, OH (US)

(21) Appl. No.: 16/274,587

(22) Filed: Feb. 13, 2019

Related U.S. Application Data
(60) Provisional application No. 62/629,968, filed on Feb. 13, 2018.

(51) Int. Cl. F21V 21/005; H05B 33/08; F21L 14/02; F21S 2/00; F21S 4/28; F21V 23/00

(52) U.S. Cl. CPC F21V 21/005; H05B 33/083; F21L 14/023; F21W 2121/00; F21S 4/28; F21V 23/005; F21V 23/002; F21S 2/00

(57) ABSTRACT

A lamp includes a light tube and one or more circuit boards. The light tube has three or more securing elements that extend along a length of the light tube. The circuit boards have a plurality of LEDs. The light tube is configured such that the one or more circuit boards are secured to an interior of the light tube by an adjacent pair of the three or more securing elements.

### CROSS-REFERENCE TO RELATED APPLICATIONS

The present application claims the benefit of U.S. Provisional Application Ser. No. 62/629,968, filed on Feb. 13, 2018, the disclosure of which is incorporated by reference in its entirety.

### BACKGROUND

Lamps are used for providing light in various settings. For example, lamps can be used in residential settings, institutional settings, transportation settings, and industrial settings. Lamps may take the form of incandescent lamps, fluorescent lamps, light-emitting diode (LED) lamps, as well as various other types of lamps.

LED lamps may include a hollow light tube with a circuit board having a linear array of LEDs disposed within the light tube. A typical LED lamp is constructed with its one or more LEDs arranged to face in a common or single direction. Accordingly, the typical LED lamp is installed in a fixture such that the LEDs are oriented to produce light in a single, predetermined direction.

As described in U.S. Pat. No. 9,057,493 (“the '493 Patent”), LED-based lamps have been developed for use in fluorescent light fixtures to replace conventional fluorescent lamps. The '493 Patent describes an LED lamp used to replace conventional fluorescent lamps in the ceiling of locations such as schools and office buildings. In particular, the '493 Patent discloses a lamp that produces light in a first direction toward an area to be illuminated and in a second direction toward a reflector, in which the reflector reflects the light toward the area to be illuminated to create a more even distribution of light.

### SUMMARY

An exemplary embodiment of a lamp includes a light tube and one or more circuit boards. The light tube has three or more securing elements that extend along a length of the light tube. The circuit boards have a plurality of LEDs. The light tube is configured such that the one or more circuit boards are secured to an interior of the light tube by an adjacent pair of the three or more securing elements.

An exemplary embodiment of a lighting device includes a length of electrical cable and a plurality of lamps electrically coupled to the electrical cable. The lamps include a light tube and one or more circuit boards. The light tube has three or more securing elements that extend along a length of the light tube. Each of the circuit boards has a plurality of LEDs. The light tube is configured such that each of the one or more circuit boards is secured on an interior of the light tube by an adjacent pair of the three or more securing elements.

An exemplary embodiment of a light tube for a lamp includes a main body and three or more securing elements that extend along a length of the main body. Each adjacent pair of the three or more securing elements are configured to secure a circuit board to an interior of the main body. An angle between each adjacent pair of the three or more securing elements is between about 30 degrees and about 150 degrees.

### BRIEF DESCRIPTION OF THE DRAWINGS

FIG. 1 is an exploded perspective view of an exemplary embodiment of a lamp;

FIG. 2 is a perspective view of an exemplary embodiment of a string light;

FIG. 3 is a perspective view of an exemplary embodiment of a light tube for the lamp of FIG. 1;

FIG. 4 is a front view of the exemplary embodiment of the light tube of FIG. 3;

FIG. 5 is a perspective view of the exemplary embodiment of the light tube of FIG. 3 with a circuit board disposed in the light tube;

FIG. 6 is a front view of the light tube and circuit board of FIG. 5;

FIG. 7 is a perspective view of the exemplary embodiment of the light tube of FIG. 3 with three circuit boards disposed in the light tube;

FIG. 8 is a front view of the light tube and circuit boards of FIG. 7;

FIG. 9 is a top view of an exemplary embodiment of a circuit board for the lamp of FIG. 1;

FIG. 10 is a rear view of the exemplary embodiment of the circuit board of FIG. 9;

FIG. 11 is a front view of another exemplary embodiment of a light tube;

FIG. 12 is a front view of another exemplary embodiment of a light tube; and

FIG. 13 is a front view of another exemplary embodiment of a light tube.

### DETAILED DESCRIPTION

The Detailed Description describes exemplary embodiments of the invention and is not intended to limit the scope of the claims in any way. Indeed, the invention is broader than and unlimited by the exemplary embodiments, and the terms used in the claims have their full ordinary meaning. Features of components of one exemplary embodiment may be incorporated into the other exemplary embodiments. Inventions within the scope of this application may include additional features, or may have less features, than those shown in the exemplary embodiments.

Many industrial and transportation settings require lighting assemblies used for task lighting. That is, in these settings, specific tasks need to be completed that require lighting, such as, for example, construction, machining, or the like. In certain situations, these tasks must be completed in small and/or narrow locations, which means that the lighting assemblies must be capable of being fed or pulled through small openings. One form of lighting assemblies that are used in these settings are string lights, such as, for example, the string lights described in Applicant's U.S. Patent Publication No. 2016/0215942, which is incorporated herein in its entirety.

The present application is directed to a lamp that can be used in industrial settings (e.g., ship construction and maintenance settings, aircraft construction and maintenance settings, various equipment construction and maintenance settings, or any other industrial setting that requires lighting). More particularly, the present application is directed to a lamp that is capable of directing light outward along 360° of a light tube of the lamp. In certain embodiments, the lamps utilize components that are configured to direct light outward along 360° of a light tube without the need for additional adapters or clips to secure LED boards within the light tube. The present application is also directed to a string light that utilizes lamps that are capable of directing light along 360° of the lamps.

It is advantageous to have a lamp that directs light along 360° of the lamp in order to provide sufficient light in all directions. It is also advantageous to have a lamp that is capable of providing an even distribution of light without needing a separate reflector. That is, current LED lamps only direct light in a single, predetermined direction toward an area to be illuminated or direct light in two opposing direction while utilizing a reflector to direct all the light in the same direction toward a single area to be illuminated. The lamps of the present application are not limited to directing light toward a single area to be illuminated, but rather allow light to be directed with an even distribution in all directions along 360 degrees of the lamp, which is particularly advantageous for lighting fixtures used in industrial settings.

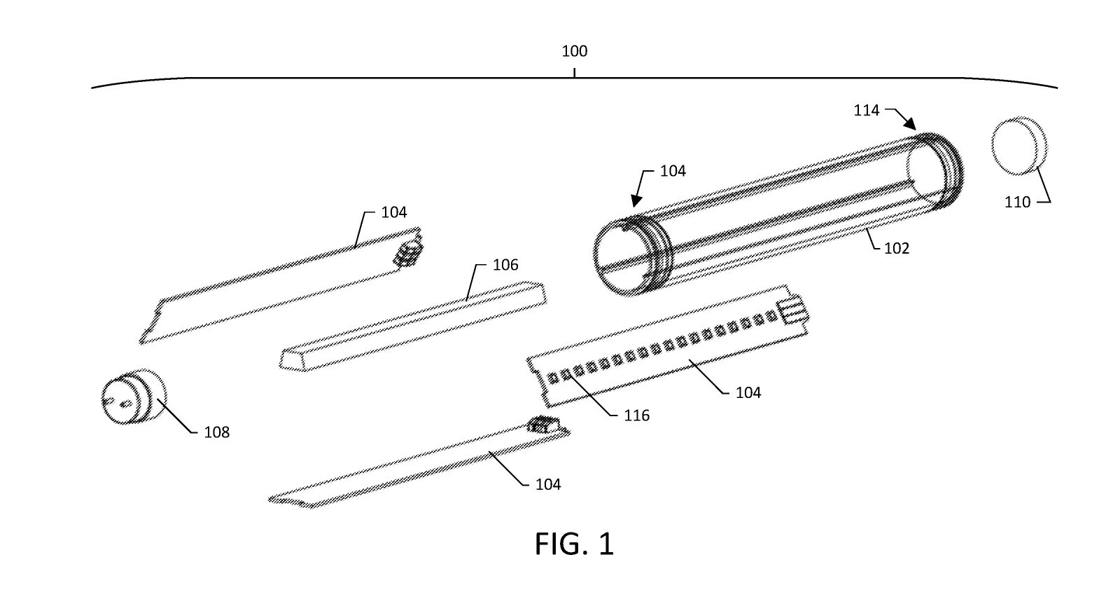

Referring to FIG. 1, an exemplary embodiment of a lamp 100 includes a light tube 102, one or more circuit boards 104, a first cover 108, and a second cover 110. The one or more circuit boards 104 are secured within the light tube 102, and the first cover 108 is connected to a first end 112 of the light tube and the second cover 110 is connected to a second end 114 of the light tube to enclose the circuit boards 104 within the light tube. In various embodiments, the lamp 100 includes a driver 106 that is configured to convert AC input current into regulated DC current that drives the circuit boards 104. Each circuit board 104 has a plurality of LEDs 116 and electric circuitry (not shown) to provide power to the LEDs. In certain embodiments, the circuit boards 104 are powered by constant current power supplies that enable the LEDs 116 to provide uniform illumination under varying input voltage conditions. The constant current power supplies provide a wide range of input voltages, which allows a single lamp 100 to cover a wide range of input voltages. When power is provided to the LEDs 116, the LEDs generate light that is directed outward through the light tube 102.

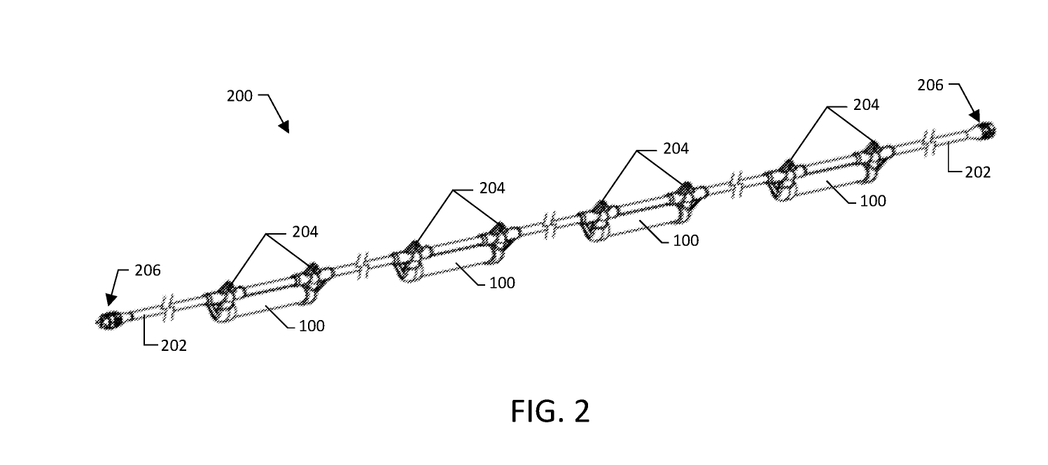

Referring to FIG. 2, an exemplary embodiment of lighting device 200 is shown. The lighting device 200 includes a length of electrical cable 202, one or more pairs of covers 204, a plurality of lamps 100 (FIG. 1), and electrical connections 206. Each of the lamps 100 are connected to the electrical cable 202 by having the covers 204 connect to the ends of the lamps. In certain embodiments, a socket (not shown) electrically connects each lamp 100 to the electrical cable 202. In one example, a socket is enclosed in one cover of each of the pairs of covers 204 such that, when an end of a lamp 100 is placed in the cover 204, the lamp is electrically connected to the electrical cable 202. The lighting device 200 may take any suitable form that is capable of generating light and directing the generated light outward through each of the lamps 100. For example, the lighting device 200 may take the form of the lighting devices described in U.S. Publication No. 2016/0215942, which is incorporated herein in its entirety.

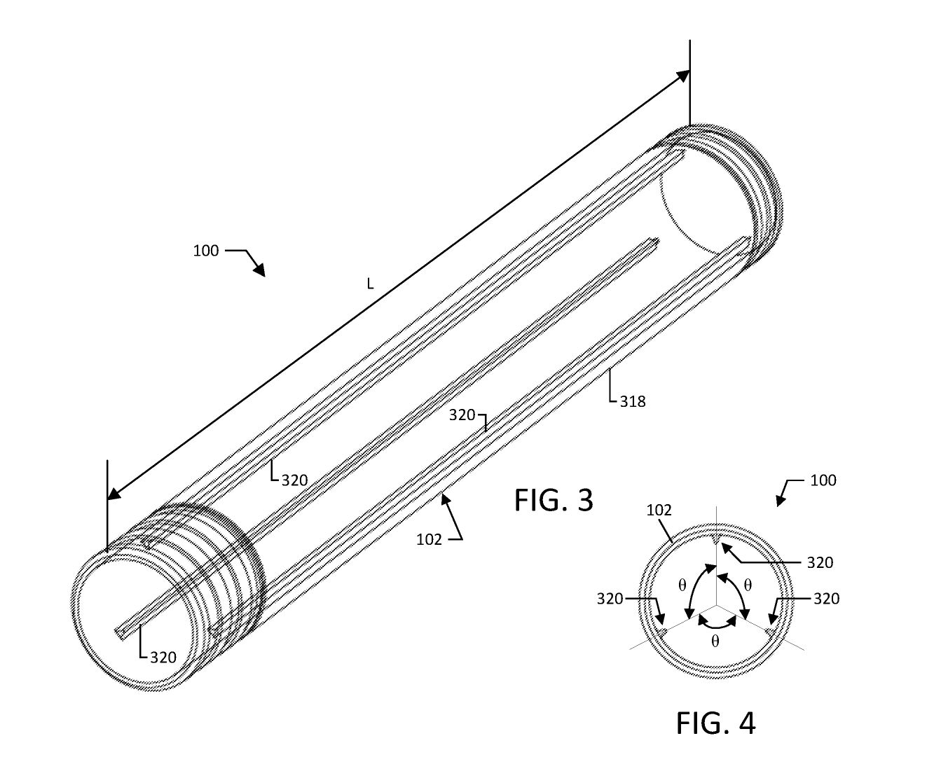

Referring to FIGS. 3 and 4, an exemplary embodiment of a light tube 102 includes a main body 318 and multiple securing elements 320 that extend along a length L of the light tube. In the illustrated embodiment, the main body 318 is a cylindrical tube. In certain embodiments, the main body 318 may be a tube having a polygonal shape. In the illustrated embodiment, the securing elements 320 are securing ribs that extend along the length of the light tube and are configured to secure the circuit boards 104 (FIG. 1) within the light tube. The securing elements 320 can, however, take any suitable form that is capable of securing the circuit boards 104 within the light tube 102. For example, the securing elements 320 can include ribs, protrusions, indentations, channels, openings, or any other suitable element for securing the circuit boards 104 to the light tube 102. While the light tubes 102 described herein are described as having securing ribs 320, it should be understood that the light tubes can have one or more securing elements for securing the circuit boards 104 to the light tube.

In certain embodiments, the light tube 102 may be made of a single piece of extruded material, as shown in the illustrated embodiment. That is, the securing ribs 320 (or other securing element(s)) and the main body 318 of the light tube 102 may be a single piece of extruded material. In other embodiments, the light tube 102 may be made of a single piece of injection molded material. In some embodiments, the securing ribs 320 extend along an entire length L of the light tube 102. In other embodiments, the securing ribs 320 do not extend along the entire length L of the light tube 102. For example, the securing ribs 320 may extend a partial length of the light tube 102, each of the securing ribs may include multiple members that are aligned on the light tube, or the securing ribs 320 may take any other suitable form that is capable of securing one or more circuit boards 104 to the light tube.

The light tube 102 may be made out of, for example, polycarbonate, acrylic glass, or the like. The light tube 102 may have any measure of transparency, such as, for example, full transparency, partial transparency, no transparency or opaque, or any other measure of transparency. In certain embodiments, the light tube 102 includes a pigment that is configured to reduce visual hot spots from the LEDs and provide a more uniform and pleasing light dispersion through the light tube. For example, in an exemplary embodiment, the pigment of the light tube is color number ZC91088 from Chroma Corporation (herein “the ZC Pigment”). The ZC Pigment combined with the polycarbonate light tube provides advantageous optical properties, such as, for example, redirecting some of the forward facing light around the inside walls of the light tube toward the rear of the lamp, which provides a degree of back-light. In one exemplary embodiment, this ZC Pigment is formulated to work with a polycarbonate light tube at 4% letdown. Alternatively, any other pigment may be used that allows light generated by the LEDs to pass through the light tube.

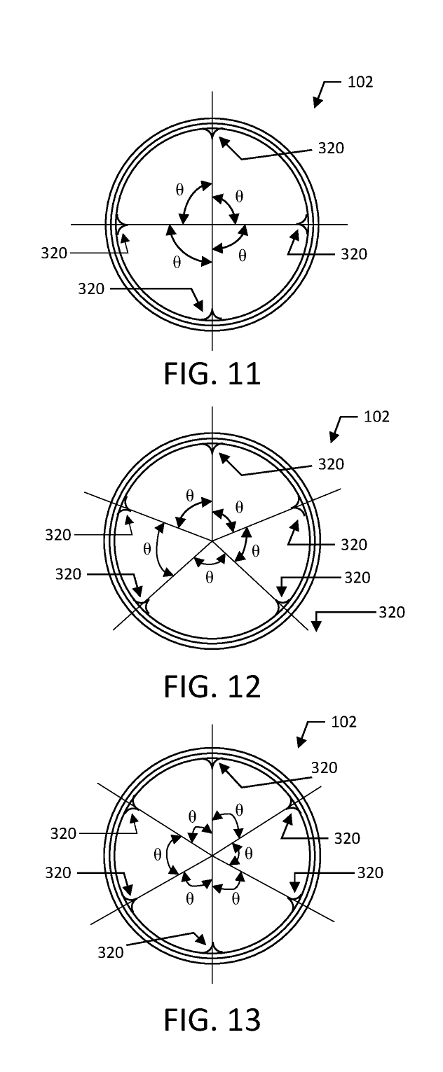

In the illustrated embodiment, the light tube 102 has three securing ribs 320. In alternative embodiments, the light tube 102 may have four or more securing ribs 320, such as, for example, four securing ribs (as shown in FIG. 11), five securing ribs (as shown in FIG. 12), six securing ribs (as shown in FIG. 13), etc. The securing ribs 320 are configured to secure one or more circuit boards 104 (FIG. 1) within the light tube 102. In certain embodiments, the securing ribs 320 may be disposed on the main body 318 of the light tube 102 such that one circuit board 104 has a solid fit between an adjacent pair of the securing ribs. That is, when a circuit board 104 is disposed between an adjacent pair of the securing ribs 320, the circuit board is prevented from being moved from its desired position within the light tube 102.

In an exemplary embodiment, each of the securing ribs 320 are disposed on the main body 318 of the light tube 102 at an angle θ from the adjacent securing ribs. In the illustrated embodiments, the angle θ between each pair of adjacent securing ribs 320 is substantially the same. That is, in the embodiment shown in FIG. 4, the angle θ between each pair of adjacent securing ribs 320 is about 120 degrees. In the embodiment shown in FIG. 11, the angle θ between each pair of adjacent securing ribs 320 is about 90 degrees. In the embodiment shown in FIG. 12, the angle θ between each pair of adjacent securing ribs 320 is about 72 degrees. In the embodiment shown in FIG. 13, the angles θ between each pair of adjacent securing ribs 320 is about 60 degrees. In embodiments in which the angle between each pair of adjacent securing ribs 320 is substantially the same, the angle θ can be between about 30 degrees and about 120 degrees. In some embodiments, the angle between at least one pair of adjacent securing ribs 320 may be different than the angle between the other pairs of adjacent securing ribs. In embodiments in which the angle between at least one pair of adjacent securing ribs 320 and another pair of adjacent securing ribs is different, the angle between an adjacent pair of securing ribs 320 can be, for example, between about 30 degrees and 150 degrees.

In certain embodiments, the angles between adjacent pairs of securing ribs 320 are configured to secure circuit boards 104 within the light tube 102 such that the LEDs on the circuit boards provide a uniform 360-degree illumination level through the light tube. That is, LEDs have a half power viewing angle of 120 degrees, which means having circuit boards secured within the light tube 102 such that an angular displacement between the circuit boards is 120 degrees or less provides for a maximum illumination level of light through the light tube. In other words, if adjacent circuit boards (having LEDs) within a light tube 102 have an angular displacement of 120 degrees or less, the light illumination profile from a center of one of the adjacent circuit boards to the center of the other of the adjacent circuit boards will reach a maximum level. Therefore, if each of the circuit boards 104 and an adjacent circuit board 104 secured in a light tube have an angular displacement of 120 degrees or less, then a uniform 360-degree illumination level is created through the light tube.

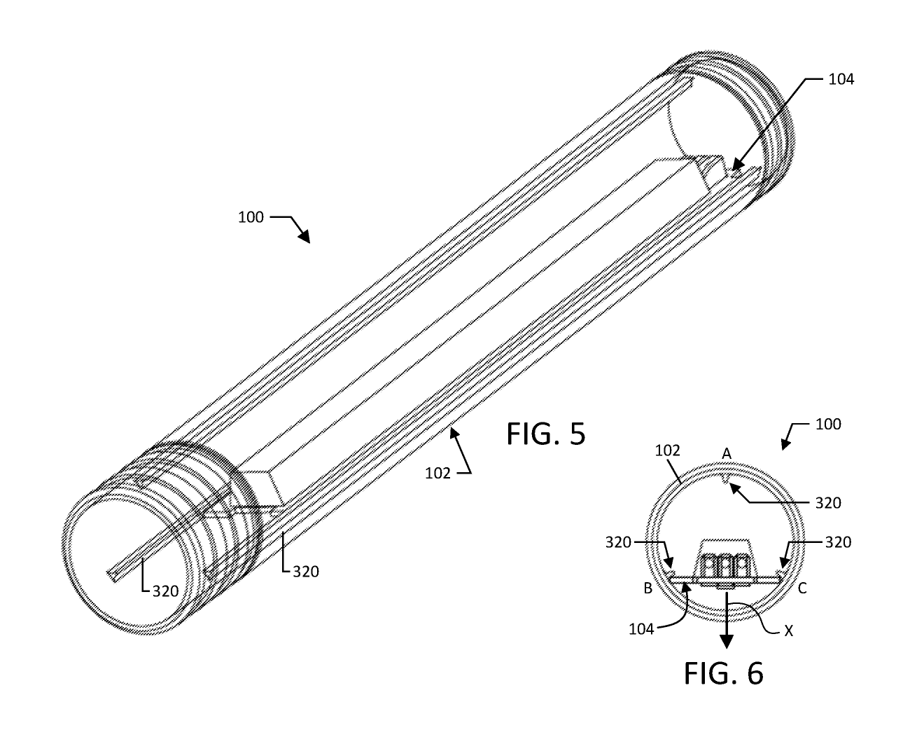

While the illustrated embodiments show a light tube 102 having three securing ribs (as shown in FIG. 4), four securing ribs (as shown in FIG. 11), five securing ribs (as shown in FIG. 12), and six securing ribs (as shown in FIG. 13), it should be understood that any suitable number of circuit boards 104 can be secured within the light tube. For example, FIGS. 5 and 6, show a light tube 102 having three securing ribs 320, in which only one circuit board 104 is secured within the light tube. In another example, while FIG. 13 shows a light tube 102 having six securing ribs 320, it should be understood that six or less circuit boards 104 can be secured to the light tube by the securing ribs. The embodiments described herein are only exemplary, and it should be understood that a light tube can have three or more securing ribs, and it should be understood that any suitable number of circuit boards can be secured to the light tube by the securing ribs.

Referring to FIGS. 5 and 6, in certain embodiments, the lamp 100 includes a light tube 102 having three securing ribs 320 and a single circuit board 104 secured within the light tube by an adjacent pair of the three securing ribs. The three securing ribs are located at points A, B, and C, respectively. In the illustrated embodiment, the circuit board 104 is secured by the securing ribs 320 located at points B and C. The circuit board 104 is disposed in the light tube 102 such that light is generated in an outward direction X through the light tube, and the circuit board is configured such that light is directed through the light tube from the securing rib at point B to the securing rib at point C.

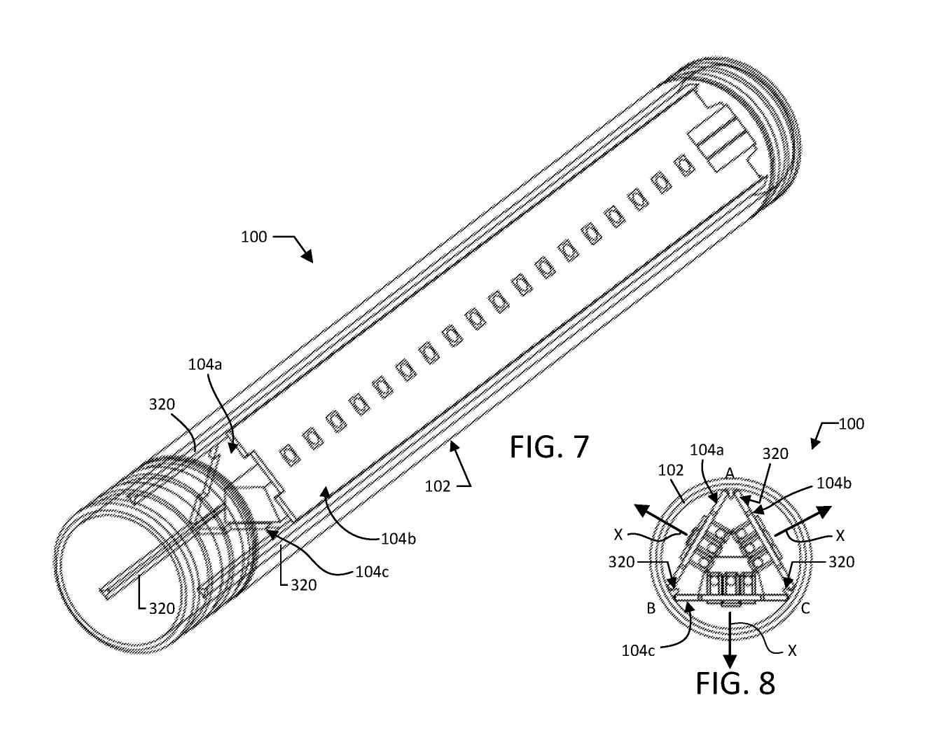

Referring to FIGS. 7 and 8, in certain embodiments, the lamp 100 includes a light tube 102 having three securing ribs 320 and three circuit boards 104a-c, in which each circuit board is secured within the light tube by an adjacent pair of the three securing ribs. The three securing ribs are located at points A, B, and C, respectively. In the illustrated embodiment, a first circuit board 104a is secured by the securing ribs 320 located at points A and B, a second circuit board 104b is secured by the securing ribs 320 located at points A and C, and a third circuit board 104c is secured by the securing ribs 320 located at points B and C. The circuit boards 104a-c are disposed in the light tube 102 such that light is generated in an outward direction X through the light tube. The circuit board 104a is disposed in the light tube 102 such that light is directed outward through the light tube from the securing rib 320 at point A to the securing rib 320 at point B. The circuit board 104b is disposed in the light tube 102 such that light is directed outward through the light tube from the securing rib 320 at point A to the securing rib 320 at point C. The circuit board 104c is disposed in the light tube 102 such that light is directed outward through the light tube from the securing rib 320 at point B to the securing rib 320 at point C. Accordingly, the lamp 100 shown in FIGS. 7 and 8 is capable of generating light directed outward along 360° of the light tube 102.

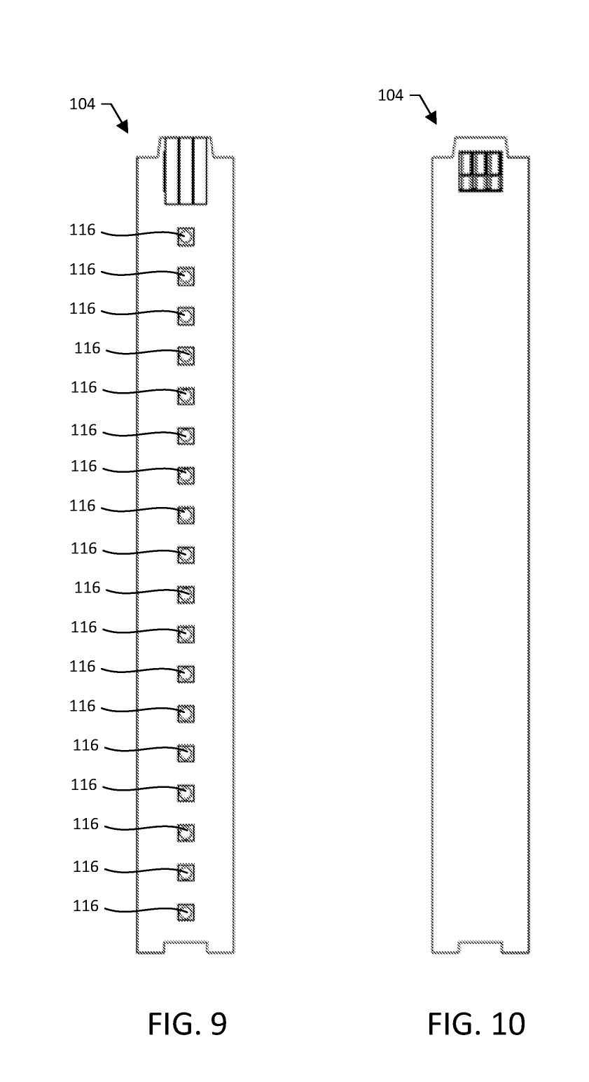

Referring to FIGS. 9 and 10, an exemplary embodiment of a circuit board 104 includes a plurality of LEDs 116. In exemplary embodiment, the circuit board 104 is made of a rigid material. A rigid circuit board is advantageous because a rigid circuit board is more easily secured between the longitudinal ridges of the light tubes described in the present application. In the illustrated embodiment, the circuit board 104 includes eighteen (18) LEDs 116. However, the circuit board may include any suitable number of LEDs 116, such as, for example, between about two (2) LEDs and about thirty-six (36) LEDs, such as between about six (6) LEDs and about thirty (30) LEDs, such as between about ten (10) LEDs and about twenty-eight (28) LEDs, such as between about fourteen (14) LEDs and about twenty-two (22) LEDs. In certain embodiments, the circuit boards 104 are powered by constant current power supplies that enable the LEDs 116 to provide uniform illumination under varying input voltage conditions.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions.

Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein.

Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated.

Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

1. A lamp comprising:
a light tube, wherein the light tube comprises three or more securing elements that extend along a length of the light tube; and
one or more circuit boards, wherein circuit boards have a plurality of LEDs;
wherein the light tube is configured such that the one or more circuit boards are secured to an interior of the light tube by an adjacent pair of the three or more securing elements.

2. The lamp according to claim 1, wherein the lamp comprises three circuit boards and three securing elements.

3. The lamp according to claim 2, wherein the circuit boards are secured to the light tube in a manner that allows light generated by the circuit boards to be directed through the light tube along 360° of the light tube.

4. The lamp according to claim 1, wherein the light tube is a single piece of extruded material.

5. The lamp according to claim 1, wherein the light tube is a single piece of injection molded material.

6. The lamp according to claim 1, wherein the light tube is made of at least one of polycarbonate and acrylic glass.

7. The lamp according to claim 1, wherein the light tube comprises a pigment configured to prevent hot spots.

8. The lamp according to claim 7, wherein the pigment comprises a ZC Pigment.

9. The lamp according to claim 1, wherein the three or more securing elements comprise three or more securing ribs.

10. The lamp according to claim 9, wherein an angle between each securing rib and an adjacent securing rib is between about 30 degrees and about 150 degrees.

11. The lamp according to claim 9, wherein an angle between each securing rib and an adjacent securing rib is about 120 degrees.

12. A lighting device comprising:
a length of electrical cable;
a plurality of lamps electrically coupled to the electrical cable, the lamps comprising:
a light tube, wherein the light tube comprises three or more securing elements that extend along a length of the light tube; and
one or more circuit boards, wherein the circuit boards have a plurality of LEDs;
wherein the light tube is configured such that the one or more circuit boards are secured to an interior of the light tube by an adjacent pair of the three or more securing elements.

13. The lighting device according to claim 12, wherein each of the lamps comprises three circuit boards and three securing elements.

14. The lighting device according to claim 13, wherein the circuit boards are secured to the light tube in a manner that allows light generated by the circuit boards to be directed through the light tube along 360° of the light tube.

15. The lighting device according to claim 12, wherein the light tube is a single piece of extruded material.

16. The lighting device according to claim 12, wherein the light tube is a single piece of injection molded material.

17. The lighting device according to claim 12, wherein the light tube is made of at least one of polycarbonate and acrylic glass.

18. The lighting device according to claim 12, wherein the light tube comprises a pigment configured to prevent hot spots.

19. The lighting device according to claim 15, wherein the pigment comprises a ZC Pigment.

20. A light tube for a lamp, the light tube comprising:
a main body;
three or more securing elements that extend along a length of the main body, wherein each adjacent pair of the three or more securing elements are configured to secure a circuit board to an interior of the main body, and wherein an angle between each adjacent pair of the three or more securing elements is between about 30 degrees and about 150 degrees.

21. The light tube according to claim 20, wherein the light tube has three securing elements.

22. The light tube according to claim 21, wherein the angle between each adjacent pair of the securing elements is about 120 degrees.

23. The light tube according to claim 20, wherein the securing elements are securing ribs.

24. The lamp according to claim 20, wherein the light tube is a single piece of extruded material.

25. The lamp according to claim 20, wherein the light tube is a single piece of injection molded material.

26. The lamp according to claim 20, wherein the light tube is made of at least one of polycarbonate and acrylic glass.

27. The lamp according to claim 20, wherein the light tube comprises a pigment configured to prevent hot spots.

28. The lamp according to claim 27, wherein the pigment comprises a ZC Pigment.
